(19) United States
(12) Patent Application Publication
(10) Pub. No.: US 2013/0247461 A1
(43) Pub. Date: Sep. 26, 2013

(54) Plant Drainage and Hydrating System

(71) Applicants: David E. Rolf, Melrose Park, IL (US); William E. Rolf, Glenview, IL (US)

(72) Inventors: David E. Rolf, Melrose Park, IL (US); William E. Rolf, Glenview, IL (US)

(21) Appl. No.: 13/426,672

(22) Filed: Mar. 22, 2012

(51) Int. Cl. A01G 9/02

(52) U.S. Cl. 47/65.6

(57) ABSTRACT

A plant drainage and hydrating system for pots with or without drainage capability. A felt layer is shaped to abut a generally flat surface, with the layer having a determined depth and having a structure to store and filter passing therethrough and support earth above the flat surface for drainage. One form of the invention has a single felt layer. A second form of the invention has first and second felt layers, separated by a spacer, with the layers connected through the spacer.

### BACKGROUND OF THE INVENTION

This invention relates to plant care, and in particular to a plant drainage and hydrating system comprising one or more structural layers for filtering and supporting soil at a pot bottom.

In a typical flower pot, one or more drainage holes are provided in the bottom, although some are not drained. When there are drainage holes, some means of preventing earth and other material in the pot from flowing through the holes is essential.

In a most rudimentary fashion, users often pile rocks or other similar debris in the bottom of a pot before earth is added, providing a fairly crude filter that, in most instances, while retaining most of the earth in the pot, still allows pot material to wash out of the pot on occasion.

Filters have been developed for pot bottoms, such as flimsy paper or cloth materials. While such materials provide a bit better means of keeping the contents within the pot, they often become clogged and ineffective as a filter, essentially preventing any drainage from the pot.

U.S. Pat. No. 7,877,970 provides a shaped porous rock or the like for locating in a pot bottom over the drainage hole. It also includes what is termed a soil amendment dispenser, which is essentially a string that wicks nutrients into the surrounding soil from the shaped porous rock.

### SUMMARY OF THE INVENTION

The invention pertains to a plant drainage and hydrating system comprising, in one form, a first felt layer is shaped to abut a bottom surface, such as a bottom of a pot, and a second felt layer is located above the first felt layer. A spacer is provided between the felt layers, and a connection is provided for connecting the felt layers to one another.

In this form of the invention, the spacer comprises a collar interposed between the felt layers. The connection comprises a joining of the felt layers within the confines of the collar. Preferably, the joining comprises fusing of one felt layer to the other felt layer.

In another form of the invention, a single felt layer is shaped to abut a generally flat surface, such as a bottom of a pot, with the layer having a determined depth, with a structure to filter water passing therethrough and support earth above the flat surface.

In this form of the invention, a liner identifier is permanently secured to the felt layer. Preferably, the permanent securing is by fusing of the liner identifier to the felt layer.

### BRIEF DESCRIPTION OF THE DRAWINGS

The invention is described in greater detail in the following description of examples embodying the best mode of the invention, taken in conjunction with the drawing figures, in which:

FIG. 1a is an elevational illustration of one form of the invention, illustrating its porosity,

FIG. 1b is an illustration similar to FIG. 1a, without illustration of the porosity,

FIG. 2a is an elevational illustration of a second form of the invention with dual layers separated by a spacer, with the layers being lined to illustrate porosity,

FIG. 2b is a view similar to FIG. 2a, without illustration of the porosity,

FIG. 3 is a cross sectional illustration of a pot showing typical deployment of the first form of the invention,

FIG. 4 is a top plan view of either of the forms of the invention, and

FIG. 5 is an isometric view with a portion cut away to illustrate detail, of the form of the invention shown in FIGS. 2a and 2b.

### DESCRIPTION OF EXAMPLES EMBODYING THE BEST MODE OF THE INVENTION

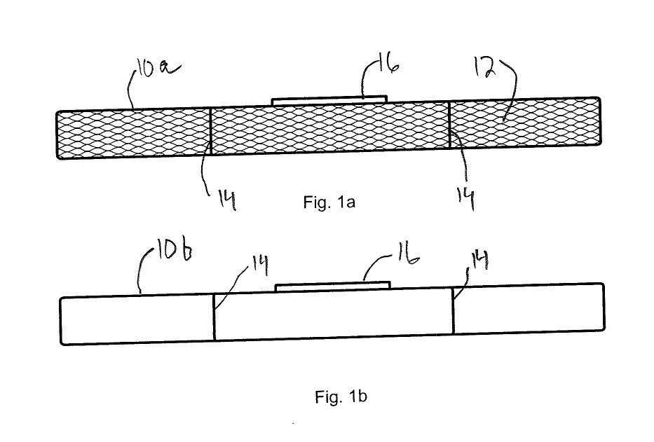

A first form of the invention is shown in FIG. 1. FIG. 1a illustrates a felt layer 10a. By “felt layer”, it is intended to be a felt material, a felt-like material, or a material that has the attributes of felt, namely filtering and water passage readily through the material, while still maintaining its structural integrity under the weight of overlying soil.

In FIG. 1a, the layer 10a is lined to illustrate the drainage and hydrating ability of the layer 10a. Thus, the reticulated lining 12 is provided to depict the porosity of the felt layer 10a.

A similar layer 10b is shown in FIG. 1b. Simply for ease of illustration, the drainage layer 10b is shown without reticulated lining, although the layer 10b also has attributes of porosity in a similar fashion as the layer 10a.

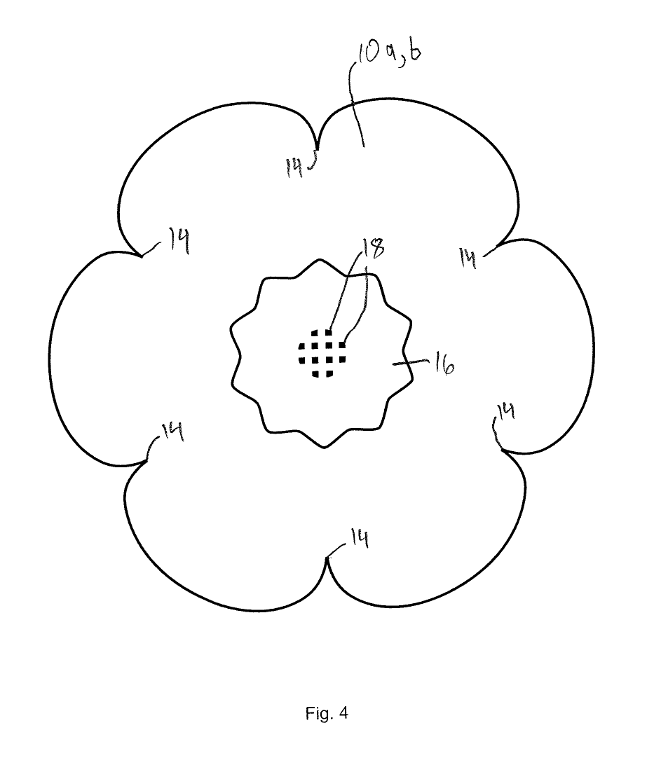

In either of the FIG. 1 versions, the layer may be shaped for aesthetic purposes. Thus, as shown in FIG. 4, the layer 10a,b may be shaped in the form of a flower petal or the like, with each of the petals adjoining the adjacent petal at a valley 14. Those valleys 14 are also shown in FIGS. 1a and 1b.

For aesthetic purposes, and to give the layers 10a and 10b a more flower-like appearance, a liner identifier 16 is secured to the layers 10a or 10b, as best shown in FIG. 4. Preferably, the identifier 16 is permanently secured to its layer 10a or 10b, such as by a series of heat stakings 18. The heat stakings 18 permanently fuse the liner identifier 16 to its respective layer 10a or 10b. Other means of attaching can also be used.

The layers 10a and 10b have a determined depth. That is, unlike paper or cloth filters, the layers 10a and 10b support the soil well above a pot bottom, allowing water to flow easily through any drainage holes. A quarter inch or more works well for the depth, although it could be less.

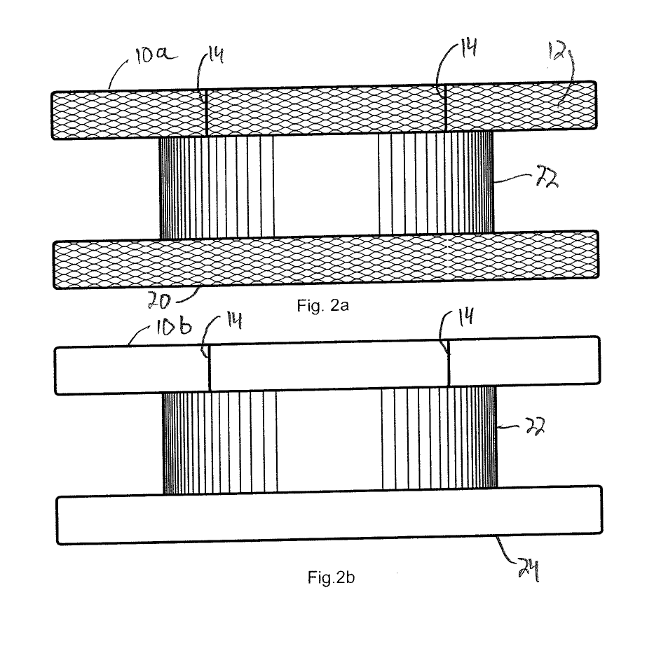

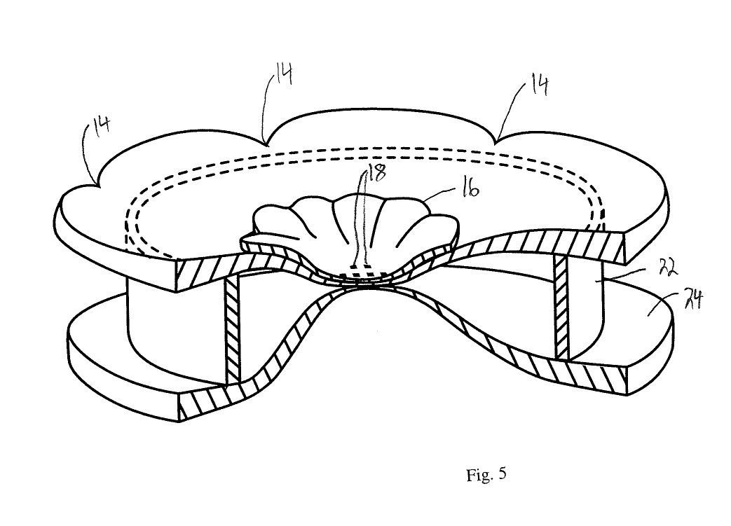

FIGS. 2 and 5 illustrate a double layer plant drainage and hydrating system. The top layer of the system can be the same as the single layers of FIG. 1, and therefore are identified with the same reference numerals.

In this form of the invention, and turning first to FIG. 2a, a second layer 20 is located beneath the upper felt layer 10a. The layer 20 can be formed of the same material as the layer 10a, and may be of the same petal shape as the layer 10a, or can simply be round or any other shape for aesthetic purposes.

A spacer 22 is located between the layers 10a and 20. Preferably the spacer 22 is an annular ring formed of a hard material to provide support, such as plastic, and the layers 10a and 20 are connected to one another through the spacer 22. Materials of sufficient strength, other than plastic, can also be used for the spacer 22. Preferably, the layers are joined by heat staking, just like the heat staking 18 illustrated in FIGS. 4 and 5, so that there is a permanent connection of the felt layer 10a to the felt layer 20 through the interior of the spacer 22. Other means of fastening can also be used, such as fasteners of various known types.

FIG. 2b is similar to FIG. 2a. The second layer 24 is separated from the layer 10b by means of the spacer 22, and the second layer 24 can be of the same shape as the layer 10b, or it can be simply a round layer or of any aesthetic shape. In any event, just as the version of FIG. 2a, the layers 10b and 24 are permanently joined to one another through the interior of the spacer 22, such as by means of heat staking as shown in FIGS. 4 and 5, or other appropriate means. The system shown in FIGS. 2a and 2b therefore comprises a unitary plant drainage and hydrating system.

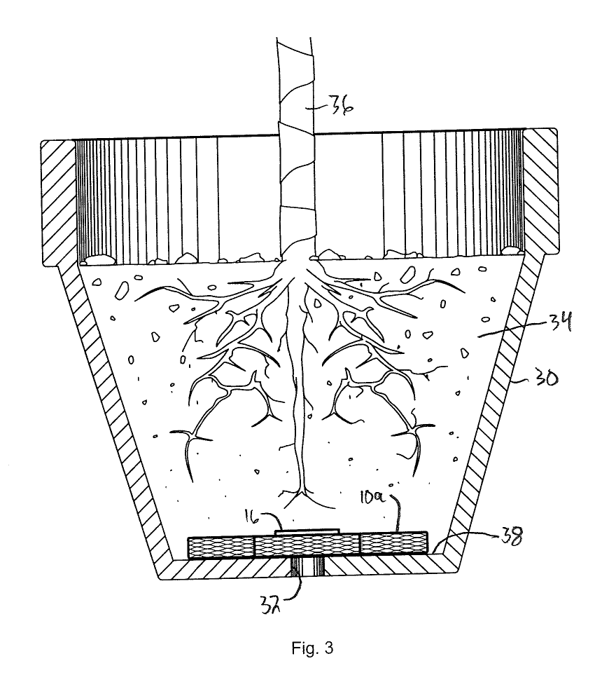

One use of the invention is depicted in FIG. 3. In FIG. 3, the felt layer 10a is located at the bottom of a conventional plant pot 30, which is shown in cross section to illustrate detail. The felt layer 10a is shown in its entirety.

The felt layer 10a is deployed over a drainage hole 32 in the pot 30 thus permitting water, but not debris in the pot 30, to flow into or out of the pot 30 via the drainage hole 32. As shown, the pot 30 is filled with appropriate plant supporting material, such as earth 34 and the like, from which a plant 36 is growing.

The layer 10a is sufficiently robust that it does not compress when the pot 30 is filled with the earth 34. Thus, the layer 10a supports the earth 34 above the flat bottom surface 38 of the pot 30, assuring that the earth 34 is well-separated from the drainage hole 32, avoiding any clogging.

The felt layer 10a forms a structure to filter water passing therethrough, either downwardly through the drainage hole to expel excess moisture, or wicking upwardly through the drainage hole 32 into the earth 34 should moisture be needed in the pot 30. It also stores water, releasing it when needed into adjoining soil. Because of the large expanse of the felt layer 10a, water can flow into, or out of, the felt layer through its entire top and sides. This assures that even if a portion of the felt layer 10a becomes clogged with minute particles of the earth 34, there will be sufficient surface area to permit water to flow into and out of the felt layer 10a, as needed.

The version of the invention shown in FIG. 2 can be used in a similar fashion, thus separating earth well above the hole 32. In addition, the FIG. 2 version can be used in a “double potting” environment, where a smaller pot is concentrically located within a somewhat larger pot so that water can be retained in the bottom of the larger pot, and either wick into or flow out of the smaller pot, as needed. Because the layers 10a and 20, or 10b and 24, are connected together, water can readily flow in any direction through the system shown in FIGS. 2 and 5. The spacer 22 supports the inner, smaller pot above water in the larger pot, allowing drainage.

The invention has several advantages over the prior art. In the version shown in FIG. 1, the invention both filters and retains earth within a pot, unlike previous plain filters that are insufficiently robust, clog, and are easily rendered. In the version shown in FIG. 2, when used in a non-drained pot, earth is maintained above any standing water, which can be wicked into the earth, as needed, as the earth dries. Also, as explained above, the version of FIG. 2 can be readily used in a double potting environment to provide wicking of moisture from the bottom pot into an upper pot, and the version of FIG. 1 can function similarly if there is contact between the two pots.

Various changes can be made to the invention without departing from the spirit thereof or scope of the following claims.

1. A plant drainage and hydrating system comprising
a. a first felt layer shaped to abut a bottom surface,
b. a second felt layer located above said first felt layer,
c. a spacer between said felt layers, and
d. a connection of said felt layers to one another by joining of said felt layers in said collar.

2. The drainage and hydrating system according to claim 1, in which said spacer comprises a collar interposed between said felt layers.

3. (canceled)

4. The drainage and hydrating system according to claim 1, in which said joining comprises fusing of one felt layer to the other felt layer,

5. The drainage and hydrating system according to claim 2, in which said collar is annular.

6. A plant drainage and hydrating system comprising
a. a felt layer shaped to abut a generally flat surface, said layer having a determined depth, and having a structure to filter water passing therethrough and support earth above the flat surface, and
b. a liner identifier permanently secured to said felt layer.

7. The drainage and hydrating system according to claim 6, in which permanent securing of said liner identifier to said felt liner is by fusing.
